(19) United States
(12) Patent Application Publication
(10) Pub. No.: US 2004/0093204 A1
(43) Pub. Date: May 13, 2004

(54) Codebood search method in celp vocoder using algebraic codebook

(76) Inventors: Kyung Jin Byun, Daejon (KR); Hee-Bum Jung, Daejon (KR); Kyung Soo Kim, Daejon (KR); Jong Dae Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/693,732

(22) Filed: Oct. 23, 2003

(30) Foreign Application Priority Data
Nov. 11, 2002 (KR) 2002-69567

(51) Int. Cl. G10L 19/10; G10L 19/08

(52) U.S. Cl. 704/219

(57) ABSTRACT

The present invention reduces complexity of computation as about 40% comparing to the conventional depth first tree search method. A method for searching an algebraic codebook in algebraic code excited linear prediction (ACELP) vocoding using a depth first tree method, includes the steps of: a) searching branches of predetermined levels to predict a branch in which optimum pulse is located; b) choosing a predetermined number of branches according to the search result of the step a) and removing residual branches; and c) searching the chosen branches and choosing optimum algebraic code.

### FIELD OF THE INVENTION

The present invention relates to a method for searching a codebook in a code excited linear prediction (CELP) vocoder using an algebraic codebook; and, more particularly, to a method for reducing codebook searching times when a depth first tree search method is used in algebraic code excited linear prediction (ACELP) vocoding using an algebraic codebook.

### DESCRIPTION OF RELATED ART

A technology for transmitting voice in digital has become widespread in a wired communication such as a telephone network, wireless communication and voice over Internet protocol (VoIP) network. It, in turn, has created interest in determining the least amount of information which can be sent over the channel while maintaining the perceived quality of the reconstructed speech.

If voice is transmitted by simply sampling and digitizing, a data rate of 64 kilobits per second (kbps) is required. However, the data rate for transmitting can be reduced by using voice analysis and appropriate coding method.

A vocoder is a device for compressing voice by extracting parameters that relate to a model of human voice. The vocoder includes an encoder and a decoder. The encoder analyzes the incoming voice so as to extract the relevant parameters. The decoder re-synthesizes the voice using the parameters received over a channel, such as a transmission channel.

A linear-prediction-based time domain vocoder is the most popular type of the vocoder. The linear-prediction-based technique extracts the correlation between the input voice samples and past samples, and encodes only the uncorrelated part. The function of the vocoder is to compress the digitized voice signal into a low bit rate signal by removing all of the natural redundancies inherent in the voice. The voice typically has short term redundancies due primarily to the filtering operation of the lips and tongue, and long term redundancies due to the vibration of the vocal cords. In a code excited linear prediction (CELP) coder, two filters, a linear predictive coding (LPC) filter and a pitch filter are used for modeling the voice. The LPC filter receives noise-like signal and is excite by a voiceless sound. Also, the LPC filter receives a quasi periodic input and is excited by a nasal sound and a vowel. Once these redundancies are removed, the resulting residual signal is modeled as white gaussian noise or multi-pulse according to a kind of CELP coding and encoded.

The CELP algorithm has been introduced for effective coding. The CELP vocoding at a rate of 4 to 8 kbps guarantees almost same quality of vocoding using other vocoders at 32 kbps. The CELP vocoder has two advantages. First, the CELP vocoder detects more detailed voice signals by extracting pitch information using a pitch predictor. Second, the CELP vocoder excites the LPC filter by using noise-like signals generated from residual signals generated from actual voice signals.

The CELP algorithm has been broadly used for voice compression at a low bit rate while guaranteeing good quality. The CELP algorithm is applied to fields of cellular communications, satellite communications and digital voice storages.

A stochastic codebook has been applied to the early CELP algorithm as a codebook. The stochastic codebook includes N number of sample codes. However, it takes long time to search the codebook because an analytic synthesis method by the CELP algorithm is used. Lately, searching time has been reduced by using a stochastic codebook based upon a linear combination of a small number of basic vectors. However, it still takes long time to search a codebook and large storage unit is required.

For overcoming above mentioned problem, an algebraic codebook has been introduced. An algebraic CELP (ACELP) algorithm is a CELP algorithm using the algebraic codebook and has been selected to many speech coding standards, e.g., global system for mobile communication-enhanced full rate (GSM-EFR), enhanced variable rate coder (EVRC) and adaptive multi-rate (AMR). The ACELP algorithm does not need a large storage unit for the codebook because the codebook is not required. Because of its effective searching method, the ACELP algorithm needs less computation amount in searching the codebook comparing to the CELP algorithm.

A limit of error to a target signal is minimized for searching a location and a magnitude of a pulse of an excited signal in the ACELP algorithm. It results large computation amount. Therefore, a focused search method and a depth first tree search method are used in the ACELP algorithm so as to reduce the computation amount.

The focused search method in G.729 codec limits a searching range by using a thresh-hold value. The depth first tree search method in G.729A searches only branches that satisfy a local maximum.

FIG. 1 is a block diagram showing encoding procedures of an ACELP vocoder using a typical algebraic codebook.

As shown, a typical ACELP vocoder uses 20 millisecond (ms) speech frames for coding and decoding. In each 20 ms interval, the encoder processes 160 samples of speech. The typical ACELP vocoder extracts pomant information, pitch information and codebook information that shows characteristics of voice signal. At step 10, DC components of input voice signals are removed by a high pass filter and a 10^{th} order coefficients of linear predictive coding (LPC) is computed by using a 30 millisecond (msec) asynchronous window and a Levinson-Durbin algorithm. At step 11, the LPC coefficients are transformed into line spectral pair (LSP) coefficients that have good linear interpolation characteristics, small quantization distortions and small transmitting errors. At step 12, the LSP coefficients are quantized.

The LPC parameters are interpolated into adequate LPC parameters for pitch searching and codebook searching.

The pitch searching is divided into a step of open-loop searching and a step of closed-loop searching. At step 13, a value of pitch delay is determined by the open-loop searching. At step 15, an impulse response is computed. At step 16, a target signal x(n) is computed and zero input responses from input voice signals is removed. At step 14, an exact value of pitch delay is determined by the closed-loop searching. The value of pitch delay has the least mean square error to the target signal.

At step 17, a target signal x₂(n) for algebraic codebook searching and the pitch signal is removed from the target signal x(n). At step 18, a location and a sign of the pulse is determined while the input voice signal has the least mean square error to the target signal x₂(n). Sub-frames of the algebraic codebook include a plurality of tracks. A predetermined number of pulses are allocated to each track to model excited signals of the sub-frame effectively. Also, magnitudes of pulses are fixed to ±1 to reduce computation. Finally, algebraic codebook information includes a location and a sign of pulses allocated in each track.

The mean square error between the input voice signal and the synthesized voice signal is expressed as following Eq. 1. Algebraic codebook searching in the ACELP algorithm is a process of finding pulses of the excited signals by minimizing a value obtained by Eq. 1.

εₖ=∥X−gHcₖ∥² [Eq. 1]

Referring to Eq. 1, X is a target signal from which a predicted gain of an adaptive codebook is removed and g is a codebook gain. H is expressed as h^{t}h and is a lower triangular toepliz convolution matrix that is generated from the impulse function of weighted synthesis filter. cₖ is an algebraic code vector.

$$H = [ \begin{matrix}h ( 0 ) & 0 & 0 & 0 & 0 \\ h ( 0 ) & h ( 0 ) & 0 & 0 & 0 \\ h ( 0 ) & h ( 1 ) & h ( 0 ) & 0 & 0 \\ ⋯ & ⋯ & ⋯ & ⋯ & ⋯ \\ h ( n - 1 ) & h ( n - 1 ) & ⋯ & h ( 1 ) & h ( 0 )\end{matrix} ] \qquad [ Eq . 2 ]$$

h(n) is an impulse response and a magnitude of a sub-frame, n is 40. Eq. 1 can be described as following Eq. 3.

$${ϵ}_{k} = {x}^{′} x - \frac{{( {x}^{t} H {c}_{k} )}^{2}}{{c}_{k}^{t} {H}^{t} H {c}_{k}} \qquad [ Eq . 3 ]$$

An optimal code vector can be determined from Eq. 3 by maximizing a result of following Eq. 4.

$${T}_{k} = \frac{{( {C}_{k} )}^{2}}{{E}_{k}} = \frac{{( H x {c}_{k} )}^{2}}{{c}_{k}^{ t} {H}^{t} H {c}_{k}} = \frac{{( {d}^{ t} {c}_{k} )}^{2}}{{c}_{k}^{ t} Φ {c}_{k}} \qquad [ Eq . 4 ]$$

d is a signal that shows correlation between the target signal x(n) and the impulse response h(n). d is called a reverse filtered target signal and is expressed as: d=H^{t}x. x is a target signal from which a predicted gain of an adaptive codebook is removed. Φ is a correlation matrix of h(n) and is expressed as: Φ=H^{t}H .

A numerator of Eq. 4 can be described as below Eq. 5 because an algebraic code vector includes small number of pulses that are non-zero.

$${C}_{k} = {\sum }_{t = 0}^{{N}_{p} - 1} {s}_{i} d ( {m}_{i} ) \qquad [ Eq . 5 ]$$

mᵢ is an i^{th} location of a pulse, sᵢ is a sign of a pulse and Nₚ is the number of pulses.

A denominator of Eq. 5 can be described as below Eq. 6.

$${E}_{k} = {\sum }_{t = 0}^{{N}_{p} - 1} Φ ( {m}_{i} , {m}_{j} ) + 2 {\sum }_{t = 0}^{{N}_{p} - 1} {\sum }_{t = j + 1}^{{N}_{p} - 2} {s}_{i} {s}_{j} Φ ( {m}_{i} , {m}_{j} ) \qquad [ Eq . 6 ]$$

d(n) and Φ(i,j) are computed in advance in Eq. 6 to reduce computation amount. mⱼ is j^{th} location of a pulse. The focused search method and the depth first tree search method are used in the ACELP algorithm so as to reduce computation.

A thresh-hold value is computed in advance to simplify the search process in the focused search method. However, if the number of pulses is increased, the implementation of the focused search method becomes difficult.

The depth first tree search method is modified method of the focused search method and searches branches that satisfy a local maximum.

The depth first tree search method is applied to the GSM-EFR codec. When 10 pulses are chosen from 40 pulses in the GSM-EFR codec, a combination is ₄₀C₁₀=847*10⁶ times. However, when the depth first tree search method is applied in the GSM-EFR codec, the number of search is 4*(4*(8*8))=1024 times.

However, a predetermined number of pulses are allocated to each track to model excited signals of the sub-frame effectively in the algebraic codebook. Also, magnitudes of pulses are fixed to ±1 to reduce computation. 40 sub-frames are divided into 5 tracks and each track uses two pulses in the GSM-EFR codec.

TABLE 1

| Track | Pulse | Position |
|---|---|---|
| 1 | i0, i5 | 0, 5, 10, 15, 20, 25, 30, 35 |
| 2 | i1, i6 | 1, 6, 11, 16, 21, 26, 31, 36 |
| 3 | i2, i7 | 2, 7, 12, 17, 22, 27, 32, 37 |
| 4 | i3, i8 | 3, 8, 13, 18, 23, 28, 33, 38 |
| 5 | i4, i9 | 4, 9, 14, 19, 24, 29, 34, 39 |

Although the number of search in the GSM-EFR codec is reduced to 1024 times by using the depth first tree search method, the computation amount for searching is still large and takes 40% of total computation amount.

### SUMMARY OF THE INVENTION

It is, therefore, an object of the present invention to provide a method for searching algebraic codebook having small computation amount by limiting the number of searching trees in an algebraic codebook in algebraic code excited linear prediction (ACELP) vocoder using depth first tree method.

In accordance with an aspect of the present invention, there is provided a method for searching an algebraic codebook in ACELP vocoding using a depth first tree method, including the steps of: a) searching at a predetermined level to predict a tree in which optimum pulse is located; b) choosing a predetermined number of trees according to the search result of the step a) and remove a residual trees; c) searching the chosen trees and choosing optimum algebraic code.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram showing encoding procedures of an ACELP vocoder using a typical algebraic codebook;

FIG. 2 is a flowchart showing a method for searching algebraic code in an algebraic codebook in accordance with the present invention;

FIG. 3 is an exemplary diagram showing a tree having levels for searching an algebraic codebook in accordance with the present invention;

FIG. 4 is an exemplary diagram showing maximum values in each track and a maximum value in total tracks in accordance with the present invention;

FIG. 5 is an exemplary diagram showing fixation of pulses and searching of pulses in an algebraic codebook in accordance with the present invention; and

FIG. 6 is an exemplary diagram showing search results of 10 total pulses in accordance with the present invention.

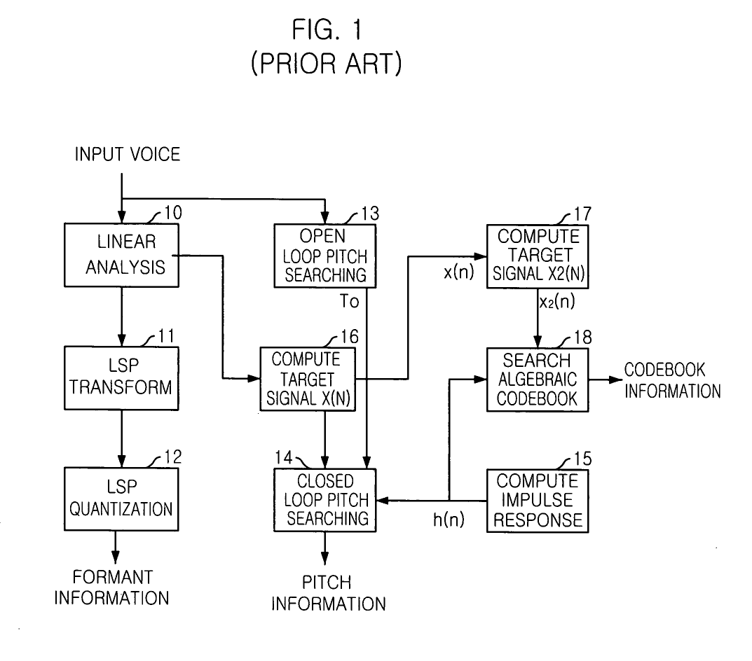

### DETAILED DESCRIPTION OF THE INVENTION

Other objects and aspects of the invention will become apparent from the following description of the embodiments with reference to the accompanying drawings, which is set forth hereinafter.

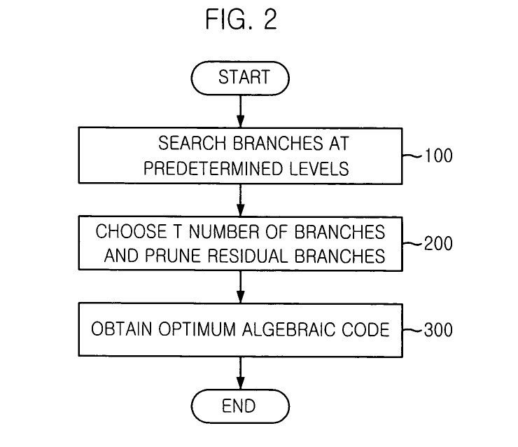

FIG. 2 is a flowchart showing a method for searching algebraic code in an algebraic codebook in accordance with the present invention.

Referring to FIG. 2, at step 100, a tree is searched to a certain level by using the depth first tree search method to predict an optimum location of a pulse. At step 200, adequate branches are chosen and residual branches are removed according to the search results of the step 100. At step 300, an optimum algebraic code is chosen.

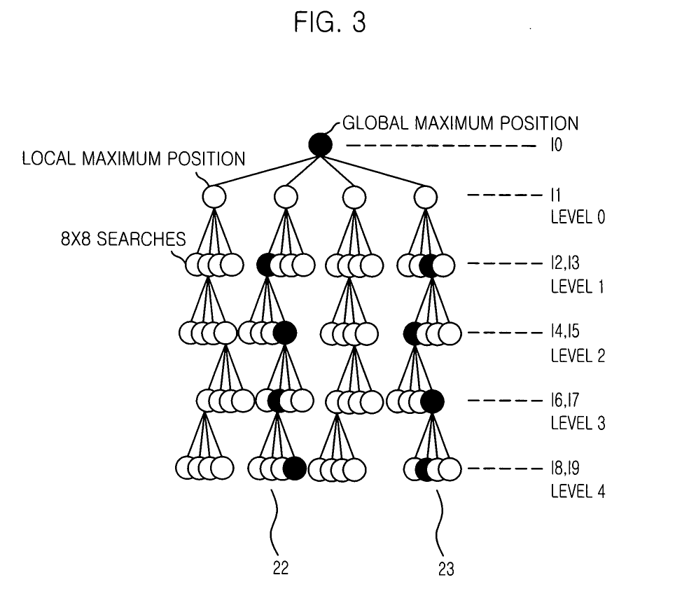

FIG. 3 is an exemplary diagram showing a tree having levels for searching an algebraic codebook in accordance with the present invention.

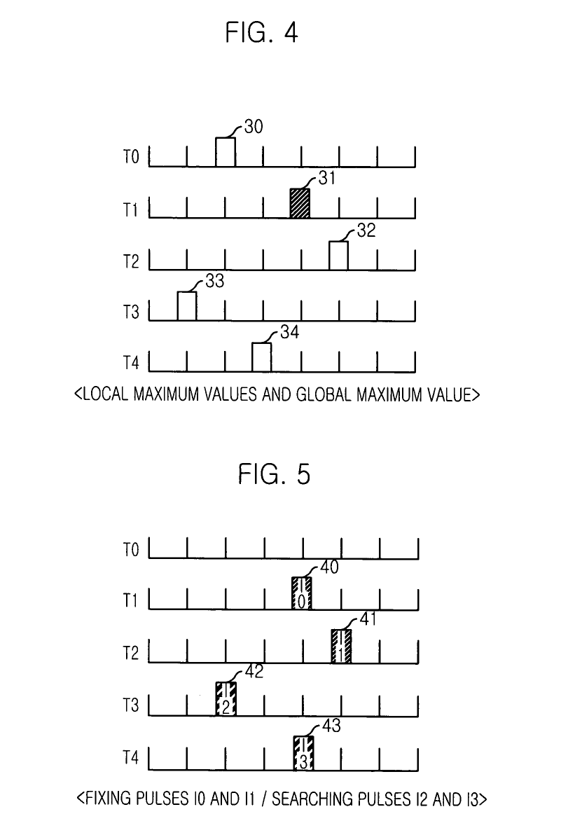

FIG. 4 is an exemplary diagram showing maximum values in each track and a maximum value in total tracks in accordance with the present invention.

FIG. 5 is an exemplary diagram showing fixation of pulses and searching of pulses in an algebraic codebook in accordance with the present invention.

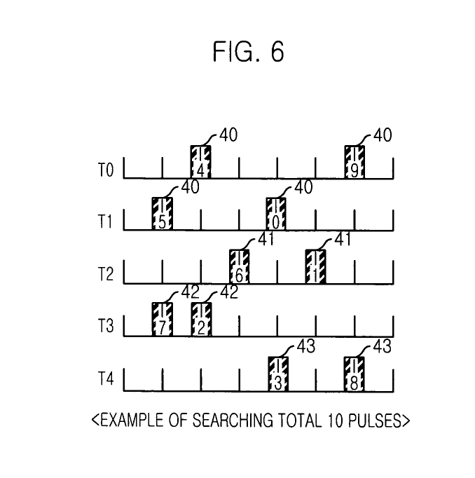

FIG. 6 is an exemplary diagram showing search results of 10 total pulses in accordance with the present invention.

First, b(n) is a sum of normalized backward filtered target signals and normalized long-term prediction residual signals. Maximum values of b(n) in each tracks are determined and stored in pos-max[ ] as shown in FIG. 4.

Second, a global maximum, 31 in FIG. 4, is stored in ipos[0] and a location of the global maximum is stored in pos-max[ipos[ ]].

Third, first pulse, an i0 is fixed as shown in 40 in FIG. 5 and a second pulse, i1, is fixed in a location of a maximum value in the next track as shown in 41 in FIG. 5.

Forth, a maximum value is determined by searching two tracks, T3 and T4, for 8*8 times as shown in 42 and 43 in FIG. 5.

Fifth, a pulse pair, i2 and i3, is chosen by rotating starting point of i1.

For example, if i1 is located in local maximum of T3, T2 and T3 are searched for locations of i2 and i3. i1 subsequently changes a location from 32 to 33, 34 and 30 as shown in FIG. 4. Therefore, the number of search is 4×(8×8)=256.

Sixth, two large values, 22 and 23 in FIG. 3, are chosen by computation using Eq. 4 and residual branches that are not likely to be chosen are removed.

Seventh, i4 and i5, i6 and i7, i8 and i9, are searched and determined according to the two chosen branches as shown in FIG. 6. The number of searching is 2×(3×(8×8))=384.

Two branches are chosen at level 1 and residual branches are removed. The number of searching is total 640 times that sums 256 times at fifth step and 384 times at seventh step.

However, 1024 times of searching are necessary in the prior method. Therefore, the present invention reduces 40% of computation amount.

When the number of searching is generalized, the number of trees that are chosen is T and the level at which branches are chosen is L. Total searching is 4×L×(8×8)+T×(4−L)×(8×8) times that sums 4×L×(8×8) times and T×(4−L)×(8×8) times.

The computation result of searching is shown in Table 2.

TABLE 2

| Tree | Level 0 | Level 1 | Level 2 | Level 3 | Level 4 |
|---|---|---|---|---|---|
| 1 | 256 (25.0%) | 448 (43.8%) | 640 (62.5%) | 832 (81.3%) | 1024 |
| | | | | | (100%) |
| 2 | 512 (50.0%) | 640 (62.5%) | 768 (75.0%) | 896 (87.5%) | 1024 |
| | | | | | (100%) |
| 3 | 786 (75.0%) | 832 (81.3%) | 896 (87.5%) | 960 (93.8%) | 1024 |
| | | | | | (100%) |

For example, when two trees are chosen at level 2 to raise provability, total number of searching is 768 times and 25% of computation is reduced.

Also, when two trees are chosen at level 1, total number of searching is 640 times and 25% of computation amount is reduced.

As mentioned above, the present invention can reduce complexity of computation as about 40% comparing to the conventional depth first tree search method. As the computation amount is reduced, a low price digital signal processing (DSP) chip is available to implement the ACELP algorithm and low power is consumed for the computation. Therefore, the method in accordance with the present invention provides compatibility for a potable vocoder by allowing more time to use the potable vocoder because the computation amount directly affects power consumption of the vocoder.

While the present invention has been described with respect to certain preferred embodiment, it will be apparent to those skilled in the art that various changes and modifications may be made without departing from the scope of the invention as defined in the following claims.

What is claimed is:

1. A method for searching an algebraic codebook in algebraic code excited linear prediction (ACELP) vocoding using a depth first tree method, the method comprising the steps of:
a) searching nodes of a tree at predetermined levels in order to predict a branch in which optimum pulse is located;
b) choosing a predetermined number of branches according to the search result of the step a) and removing residual branches; and
c) searching the chosen branches and choosing optimum algebraic code.

2. The method as recited in claim 1, wherein step a) includes the steps of:
a1) determining a level ‘L’ at which branches are searched;
a2) finding maximum values of each track;
a3) fixing a maximum value in total tracks as a first pulse;
a4) fixing a maximum value in a next track blow the track at which the first pulse is found as a second pulse;
a5) searching a third pulse and a forth pulse at next two tracks below the track at which the second pulse is found; and
a6) fixing other maximum value except the first pulse as the second pulse and executing the step a5).

3. The method as recited in claim 1, wherein T number of branches is chosen based on an equation as:
$${T}_{k} = \frac{{( {C}_{k} )}^{2}}{{E}_{k}} = \frac{{( H x {c}_{k} )}^{2}}{{c}_{k}^{ t} {H}^{t} H {c}_{k}} = \frac{{( {d}^{ t} {c}_{k} )}^{2}}{{c}_{k}^{ t} Φ {c}_{k}} ,$$
wherein Eₖ represents energy of synthesized signal, Cₖ means correlation between target signal and synthesized signal, x is a target signal from which a predicted gain of an adaptive codebook is removed, H is a lower triangular toepliz convolution matrix, H^{t} is a transposed matrix of H, cₓ is an algebraic code vector, cₓ^{t} is a transposed matrix of cₓ, d is a reverse filtered target signal, d^{t} is a transposed matrix of d, Φ is a correlation matrix of h(n), which is impulse response.

4. The method as recited in claim 1, wherein in case of searching locations of two pulses in each track that has locations of 8 pulses in the algebraic codebook that has 5 tracks, the number of searching at a predetermined level ‘L’ is 4×L×(8×8) times.

5. The method as recited in claim 4, wherein the number of searching a predetermined number of chosen branches ‘T’ is T×(4−L)×(8×8) times.

6. The method as recited in claim 1, wherein in case of searching locations of two pulses in each track that has locations of 8 pulses in the algebraic codebook that has 5 tracks, a total number of searching is 4×L×(8×8)+T×(4−L)×(8×8) times.
